(19) United States
(12) Patent Application Publication
(10) Pub. No.: US 2006/0187960 A1
(43) Pub. Date: Aug. 24, 2006

(54) Network interface and computing system including the same

(76) Inventors: Toshihiko Murakami, Fujisawa-shi (JP); Makio Mizuno, Sagamihara-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/119,901

(22) Filed: May 3, 2005

(30) Foreign Application Priority Data
Feb. 23, 2005 (JP) 2005-046421

(51) Int. Cl. H04J 3/22

(52) U.S. Cl. 370/469

(57) ABSTRACT

Disclosed is a network interface which enables a storage device to be connected to multiple networks of different specifications. A storage device is connected to a network through which communications are done in accordance with one or more communication protocols, and contains a network interface. This network interface includes a Physical Layer process unit for handling a signal defined by Physical Layer, a clock supply unit for storing information on a plurality of relations between clock frequencies and communication protocols, a serial conversion unit for determining a communication protocol, based on the information and a clock frequency of a received frame, or for determining a clock frequency of a frame to be sent, based on the information and a communication protocol of the frame, and a multi-protocol process unit for handling the frame, in accordance with the determined communication protocol.

### CROSS-REFERENCE TO RELATED APPLICATIONS

This application claims the benefit of Japanese Patent Application 2005-046421 filed on Feb. 23, 2005, the disclosure of which is incorporated herein by reference.

### BACKGROUND OF THE INVENTION

1. Field of the Invention

The present invention relates to a network interface, and a computing system including the same.

2. Description of the Related Art

The way how storage devices equipped with a memory means are used on a network has been popular (see Japanese Unexamined Patent Application Publication 10-69357). A typical example of such a network is a storage area network (SAN). By way of a network of this type, a certain device can access a memory means of a storage device.

As for protocols for allowing storage devices to connect with a network, various types of protocols have been proposed by storage device vendors or network standard organizations. As long as devices are compliant with the same protocol, they can communicate with one another. However, if the protocols of devices differ from each other, then they fail to communicate.

Conventionally, when a storage device is connected to a network, if the device does not support a protocol of the network, it needs to have a network interface board dedicated to the protocol. Accordingly, if being connected to multiple networks of different protocols, a storage device is required to have as many network interface boards as the protocols. This ends up enlarging a storage device. As a result, the development and control costs towards device vendors are increased. In addition, users of storage devices need to purchase a network interface board for each protocol. This causes the increase in introduction costs.

Taking the above disadvantage into account, the present invention has been conceived. An object of the present invention is to provide storage devices at low costs which are adapted for multiple networks of different specifications.

### SUMMARY OF THE INVENTION

According to an aspect of the present invention, there is provided, a network interface that is contained in a storage device connected to a network through which communications are done in accordance with one or more communication protocols, the network interface is constituted as follows:

(1a) a Physical Layer process unit for handling a signal defined by Physical Layer;

(1b) a clock supply unit for storing information on a plurality of relations between clock frequencies and communication protocols;

(1c) a serial conversion unit for determining a communication protocol, based on the information and a clock frequency of a received frame, or for determining a clock frequency of a frame to be sent, based on the information and a communication protocol of the frame; and

(1d) a multi-protocol process unit for handling the frame, in accordance with the determined communication protocol.

According to another aspect of the present invention, there is provided, a computing system is constituted as follow:

(2a) a network enables communications to be done in accordance with one or more protocols;

(2b) at least one storage device connected to the network;

(2c) at least one host connected to the network; and

(2d) a network interface included in the storage device.

Furthermore, this network interface is constituted as follow:

(2aa) a Physical Layer process unit for handling a signal defined by Physical Layer;

(2bb) a clock supply unit for storing information on a plurality of relations between clock frequencies and communication protocols;

(2cc) a serial conversion unit for determining a communication protocol, based on the information and a clock frequency of a received frame, or for determining a clock frequency of a frame to be sent, based on the information and the communication protocol of the frame; and

(2dd) a multi-protocol process unit for handling the frame, in accordance with the determined communication protocol.

With the above interface unit of the present invention, it is possible to provide storage devices capable of being used on multiple networks of different specifications without the requirement for adding or exchanging interface boards.

Moreover, with the above computing system of the present invention, it is possible to provide computing systems capable of handling multiple communication protocols.

Other features, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a view depicting a block diagram of a computing system according to one embodiment of the present invention;

FIG. 2 is a view depicting a block diagram of a network interface according to one embodiment of the present invention;

FIG. 3 is a view for explaining the process of a frame according to one embodiment of the present invention;

FIG. 4A is a view depicting a configuration of a clock supply unit (multi-clock purpose) according to one embodiment of the present invention;

FIG. 4B is a view depicting a configuration of a clock supply unit (multi-clock purpose) according to another embodiment of the present invention;

FIG. 5 is a view for explaining a protocol stack according to one embodiment of the present invention;

FIG. 6A is a view depicting a format of a frame according to one embodiment of the present invention;

FIG. 6B is a view depicting a format of a frame according to another embodiment of the present invention;

FIG. 7A is a view for explaining interframe gaps between frames according to one embodiment of the present invention;

FIG. 7B is a view for explaining interframe gaps between frames according to another embodiment of the present invention;

FIG. 8A is a flowchart showing an outline process of sending a frame according to one embodiment of the present invention;

FIG. 8B is a flowchart showing another outline process of sending a frame according to one embodiment of the present invention;

FIG. 9 is an exemplified flowchart showing a process of a frame according to one embodiment of the present invention;

FIG. 10 is a flowchart showing a process of receiving a frame with multiple coding schemes, according to one embodiment of the present invention;

FIG. 11 is a flowchart showing a process of sending a frame with multiple coding schemes, according to one embodiment of the present invention;

FIG. 12 is a block diagram of a computing system as a comparative example;

FIG. 13 is a block diagram of a network interface (iSCSI purpose), as a comparative example;

FIG. 14 is a block diagram of a network interface (Fibre Channel purpose), as a comparative example;

FIG. 15 is a view for explaining setting of a port setting table according to one embodiment of the present invention; and

FIG. 16 is a view depicting a configuration of the port setting table.

### DETAILED DESCRIPTION OF THE EXEMPLARY EMBODIMENTS OF THE INVENTION

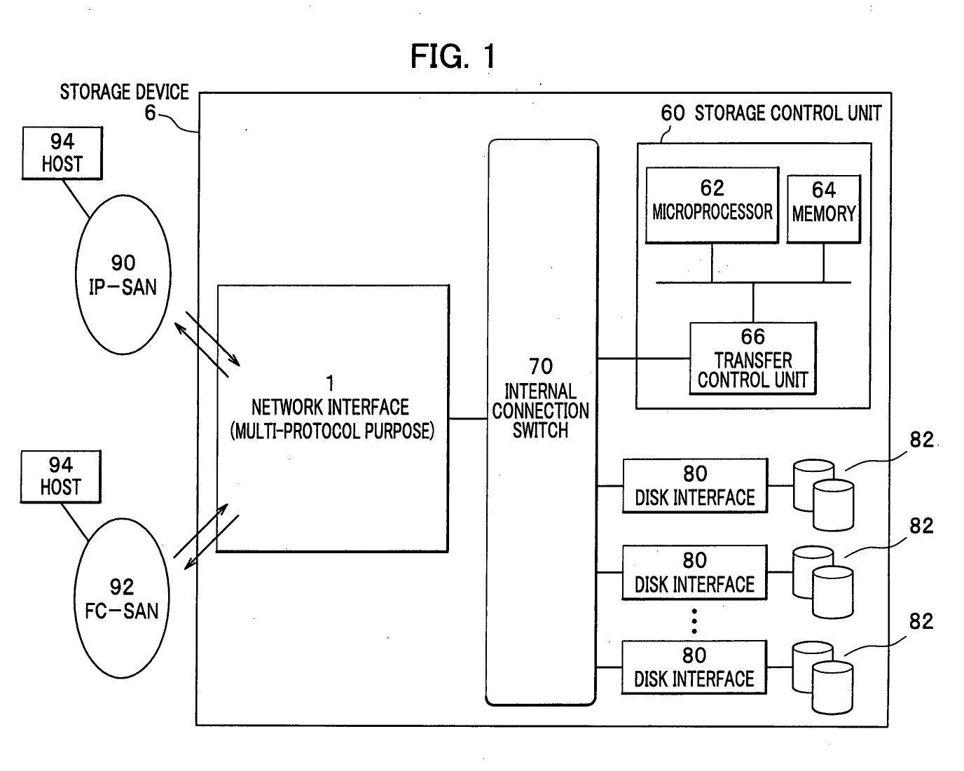

A detail description will be given below, of a computing system according to one embodiment of the present invention, with reference to accompanying drawings. First, the configuration of the computing system will be described with reference to FIGS. 1 through 7.

Referring to FIG. 1, a computing system has a storage device 6 and hosts 94 which are all interconnected through a network. Each host 94 is a computer composed of a processor and a storage means. Examples of the network include an internet protocol-storage area network (IP-SAN) 90, and a Fibre Channel-storage area network (FC-SAN) 92.

The storage device 6 is a computer that includes a storage control unit 60 that controls internal components of the storage device, a memory 64 as a storage means for use in a computing process, a processor that performs the computing process, and other components. The memory 64 may be a random access memory (RAM). Furthermore, the processor, which includes a central processing unit (CPU) such as a microprocessor 62, executes a program stored in the memory 64, whereby the computing process is carried out.

The storage device 6 further includes one or more storages 82 connected to corresponding disk interfaces 80. The internal components of the storage device 6 are connected to one another via an internal connection switch 70. The storage control unit 60 has a transfer control unit 66 connected to the internal connection switch 70.

The storage device 6 sends/receives data according to various communication protocols via the network and a network interface (multi-protocol purpose) 1. Examples of the communication protocol include Fibre Channel (FC), fibre connection (FICON) (trademark), internet small computer system interface (iSCSI), and Ethernet (trademark).

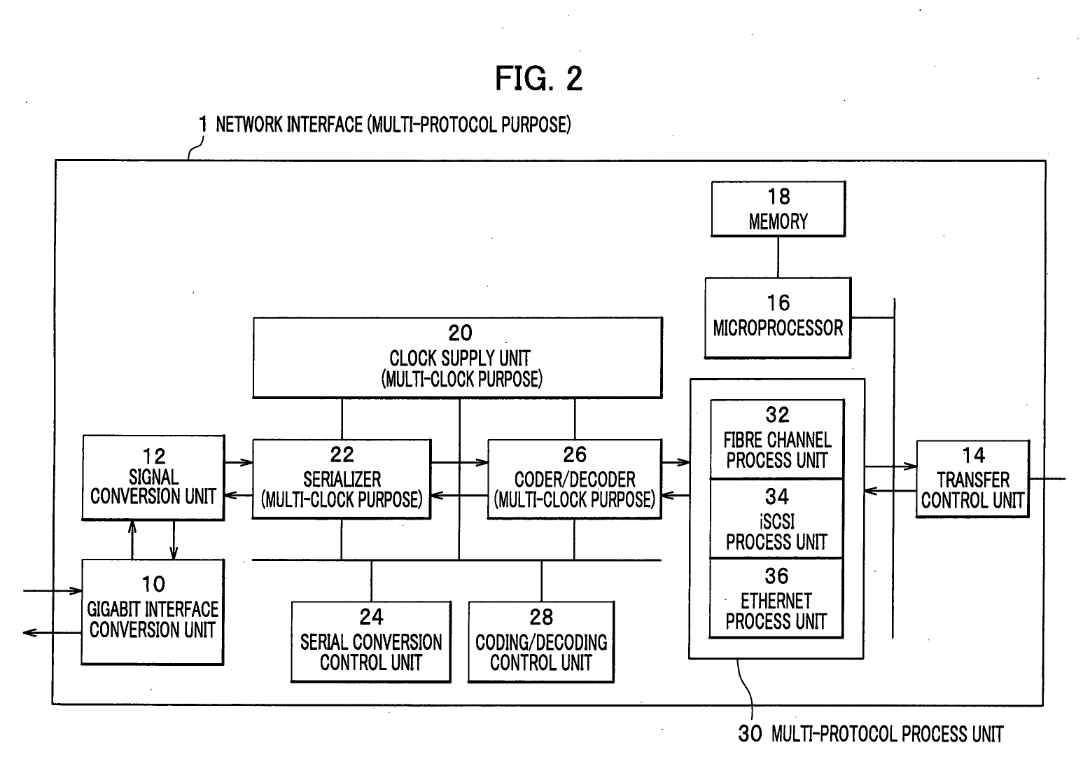

Referring to FIG. 2, the network interface 1 is a computer in which a microprocessor 16 executes a program stored in a memory 18. The network interface 1 incorporates a transfer control unit 14 connected to the internal connection switch 70. A concrete description will be given below, of components of the network interface 1.

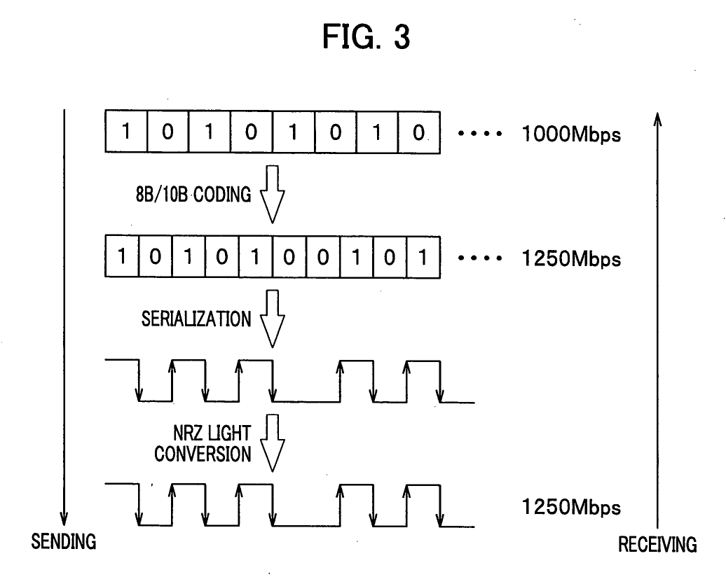

Referring to FIG. 3, a signalizing process of a frame will be illustrated. When the network interface 1 sends a frame to which a specific header and footer have been added in accordance with a protocol, the coder/decoder (multi-clock purpose) 26 first subjects the frame to an 8B/10B coding. Second, the serializer (multi-clock purpose) 22 serializes the coded frame. Finally, the signal conversion unit 12 subjects the serialized frame to Non Return to Zero (NRZ) optical conversion and, then sends it through a gigabit interface conversion unit 10. Herein, the combination of the gigabit interface conversion unit 10 and the signal conversion unit 12 is called “Physical Layer process unit”. Note that although being shown in the drawings independently of each other, the gigabit interface conversion unit 10 and the signal conversion unit 12 may be integrated on a single board.

On the other hand, when the network interface 1 receives a frame through the gigabit interface conversion unit 10, the signal conversion unit 12 first subjects the frame to the NRZ optical conversion. Second, the serializer 22 serializes the converted frame. Finally, the coder/decoder 26 subjects the serialized frame, to which the header and footer have been added in accordance with a protocol, to the 8B/10B coding, and then allocates the coded frame to the multi-protocol process unit 30.

In the network interface 1, the gigabit interface conversion unit 10 is connected to an external network such as IP-SAN 90 or FC-SAN 92 via ports (not shown). The gigabit interface conversion unit 10 performs processes regarding Physical Layer that is independent of protocols defined by Datalink Layer. The signal conversion unit 12 performs E/O or O/E conversion and waveform shaping.

The serializer 22 detects an idle code which is contained in a clock sent from another device through the network, when being connected to an external network. Subsequently, the serializer 22 permits the device to communicate with the network interface 1 by using frames corresponding to the clock frequency of the detected idle code. In other words, a communication is established by a frame of Datalink Layer, which corresponds to the clock. Alternatively, an administrator may define the condition of an idle code as “received” beforehand, although the idle code is not received.

Upon reception of a frame, the serializer 22 identifies a protocol of the permitted frame, based on the clock frequency of the detected idle code. Meanwhile, upon sending of a frame, the serializer 22 determines a clock frequency of a frame to be sent, based on a protocol of the frame.

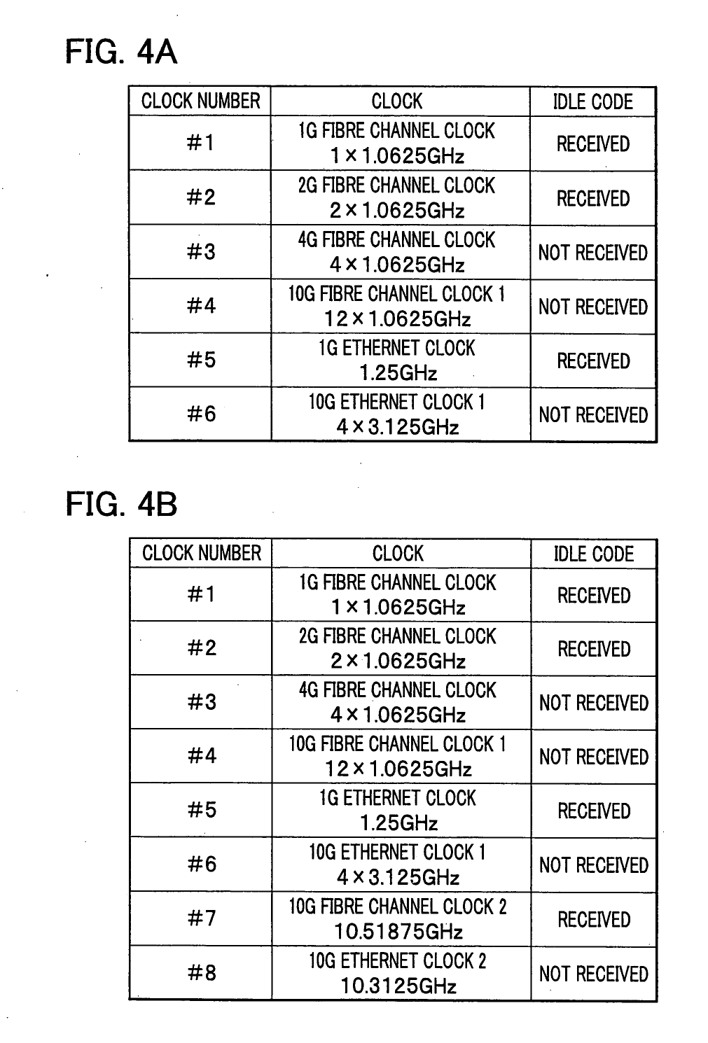

The serializer 22 acquires, from the clock supply unit (multi-clock purpose) 20, information on the relations between clock frequencies and communication protocols. FIGS. 4A and 4B show a configuration of the clock supply unit 20. Specifically, FIG. 4A shows an example of information on the relations between idle codes and frames (clock number #1 to #6) to be subjected to the 8B/10B coding (described later). FIG. 4B shows an example of information on the relations between idle codes and frames to be subjected to a 64B/66B coding (described later), in addition to the information of FIG. 4A.

In the relation information of the clock supply unit 20 shown in FIG. 4A, a clock number #1 relates 1 G Fibre Channel (protocol) to 1×1.0625 GHz (clock frequency). In addition, its idle code is received already. The serial conversion control unit 24 updates, as needed, the respective operation conditions, such as a clock frequency, of the serializer 22 and the clock supply unit 20, in response to setting of an administrator.

The coder/decoder 26 subjects a frame to be sent/received to a block coding such as the 8B/10B or 64B/66B coding. A process of such block coding is published in “10 Gbit Ethernet (trademark) kyoukasyo”, Osamu Ishida and Kouichi Seto, IDG JAPAN, pp. 141-42. The coding/decoding control unit 28 timely updates the operation conditions, such as a coding scheme, of the coding of the coder/decoder 26.

The network interface 1 assigns a process to the multi-protocol process unit 30, depending on the protocol type which is identified by the serializer 22. The multi-protocol process unit 30 is composed of several components which perform processes depending on protocol types, respectively. These components are a Fibre Channel process unit 32 that treats frames in accordance with Fibre Channel, an iSCSI process unit 34 that handles the frame in compliance with iSCSI, and an Ethernet process unit 36 that processes the frame according to Ethernet. Note that the protocol types shown in FIG. 2, which the multi-protocol process unit 30 deals with, are merely examples. It is natural that the multi-protocol process unit 30 should include any process unit in order to deal with various types of protocol.

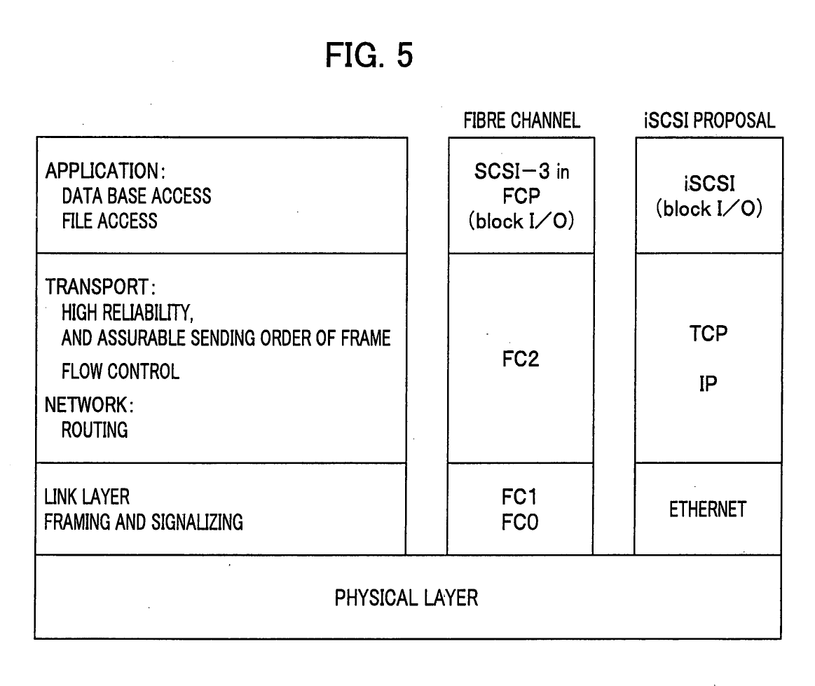

In the network interface 1, the units that deal with Physical Layer can be used commonly, independent of the protocol type, as shown in FIG. 5. As an example of the common process, a block coding is cited. This process is used commonly in both Ethernet and Fibre Channel. Note that the 8B/10B coding is used mainly in G bit.

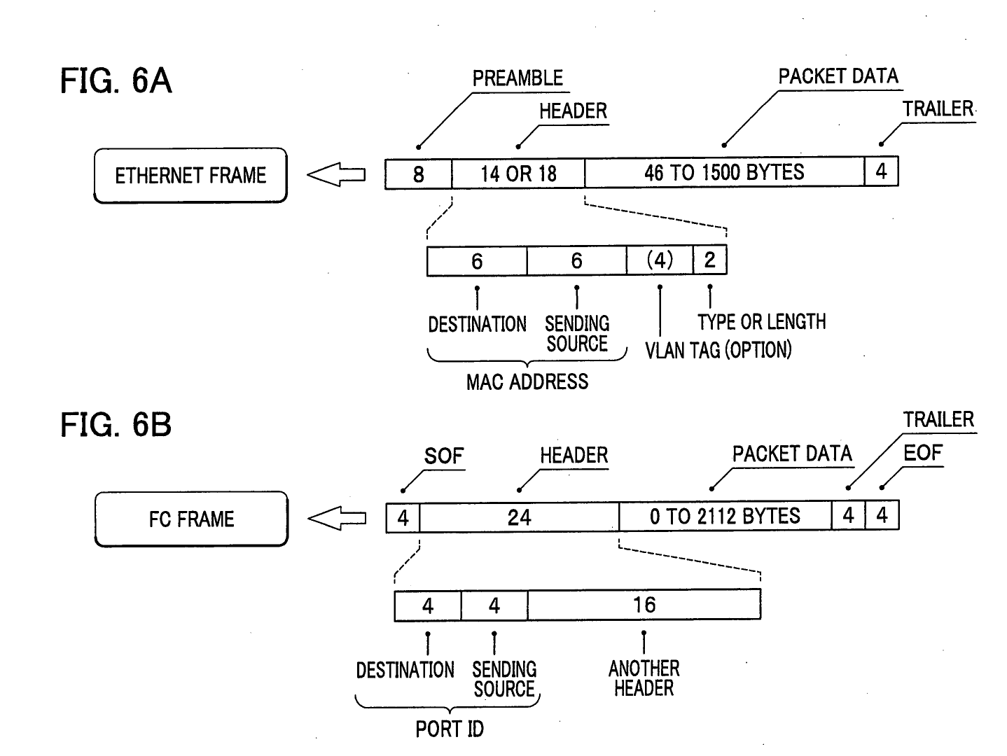

FIGS. 6A and 6B show the formats of Ethernet and Fibre Channel frames, respectively. The multi-protocol process unit 30 subjects the frame of Ethernet to an iSCSI or network attached storage (NAS) process. Meanwhile, it subjects the frame of Fibre Channel to a Fibre Channel or FICON process. The multi-protocol process unit 30 is provided with means for performing the above both processes, independently of each other, so that multiple protocols are treated. In this embodiment, the formats of the standard frames shown in FIGS. 6A and 6B are not converted. Accordingly, the compatibility between this device and a conventional device can be maintained. This makes it possible to utilize existing resources, thus constructing a system at low costs.

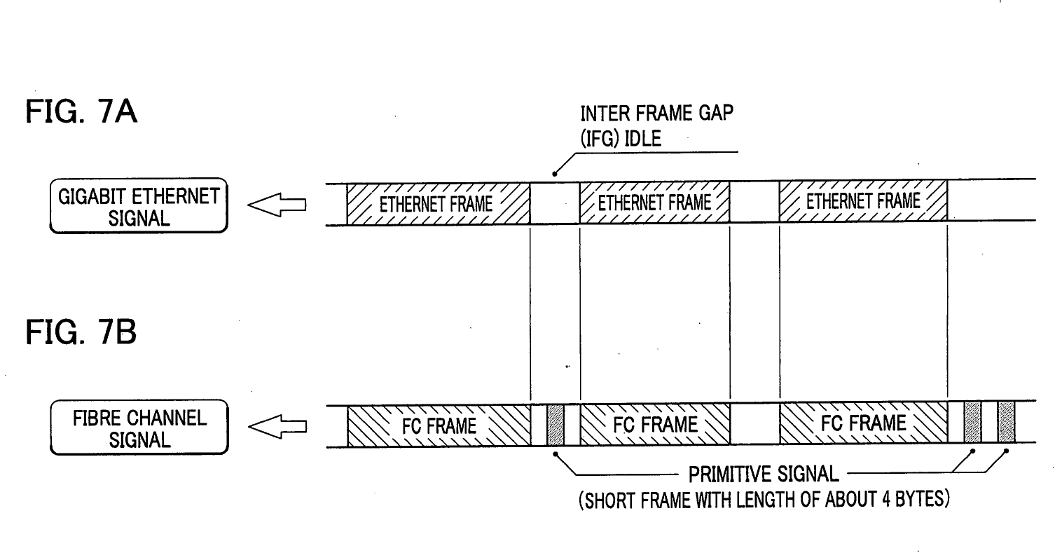

As shown in FIGS. 7A and 7B, either of signals according to gigabit Ethernet and FC frames according to Fibre Channel contains idle codes at the interval between individual frames. In addition, each inter frame gap (IFG) of Fibre Channel contains a primitive signal.

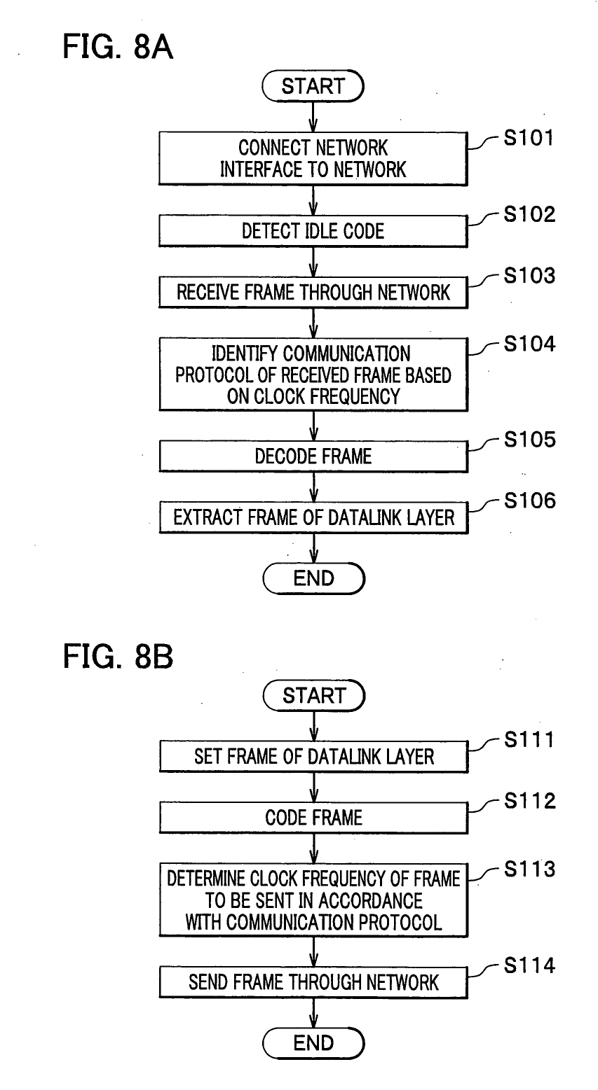

As described above, the configuration of the computing system has been described. Next, an operation of the computing system will be described with reference to FIGS. 7A and 7B as well as FIGS. 8A through 11.

FIG. 8A shows a flowchart of a process in which the storage device 6 receives a frame.

First, the gigabit interface conversion unit 10 of the network interface 1 is connected to a network (S101) Second, the serializer 22 detects an idle code through the network (S102). Subsequently, the serializer 22 permits frames, which correspond to the clock frequency of the detected idle code, to be communicated.

The gigabit interface conversion unit 10 and the signal conversion unit 12 receive the permitted frames through the network (S103). Subsequently, the serializer 22 identifies a protocol of the permitted frames, based on the clock frequency of the frames (S104). Then, the coder/decoder 26 decodes the received frame (S105). Finally, the multi-protocol process unit 30 extracts frames of Datalink Layer (S106).

FIG. 8B shows a flowchart of a process in which the storage device 6 sends a frame.

First, the multi-protocol process unit 30 sets frames of Datalink Layer as frames to be sent (S111). Second, the coder/decoder 26 codes the frames (S112). The serializer 22 sets a clock frequency of the frames, in accordance with a communication protocol of the frames (S113). Finally, the gigabit interface conversion unit 10 and the signal conversion unit 12 send the frames with the clock frequency being set at S113 through the network.

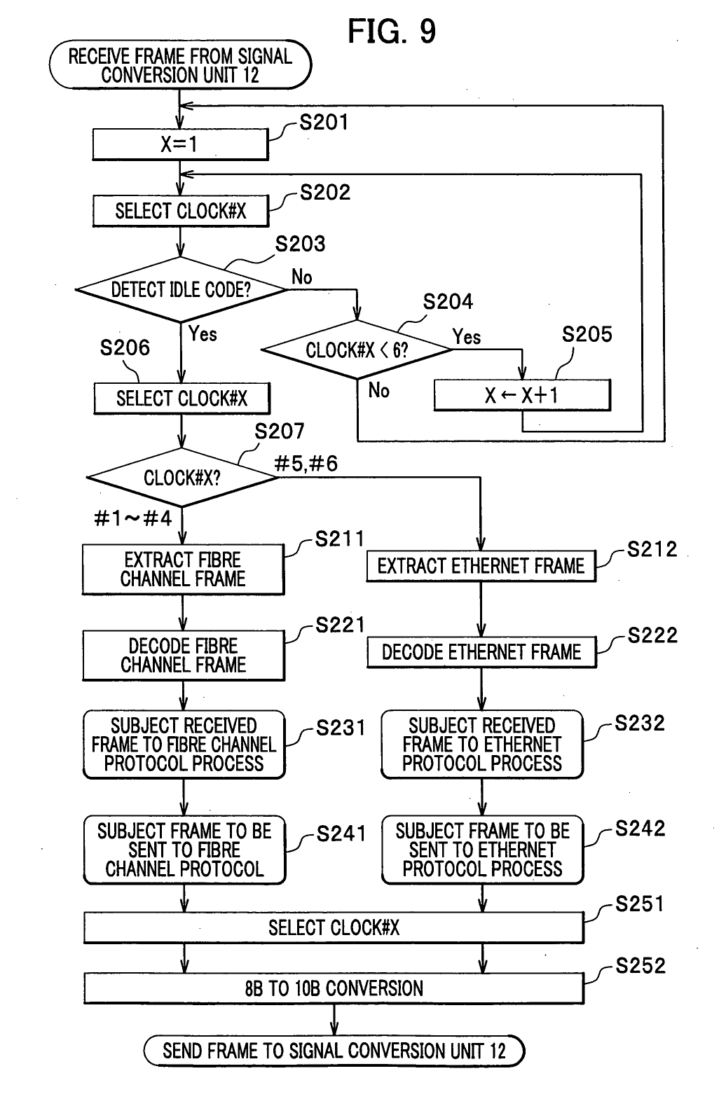

FIG. 9 shows a flowchart of an example of a process in which a frame is communicated. This flowchart shows the communicating process, assuming the clock supply unit 20 contains data shown in FIG. 4A. In FIG. 9, a single coding/decoding scheme (8B/10B coding) is employed.

A receiving process of a frame will be described below. First, the microprocessor 16 substitutes 1 in a variable X for selecting a clock (S201). Second, the serializer 22 selects a clock #X (S202). If X is equal to 1, then the serializer 22 selects a top record (clock #1) of FIG. 4A.

Next, the serializer 22 determines whether or not an idle code of the clock #X is detected (S203). For example, if this idle code is received already, then “Yes” is selected at S203.

Otherwise, if the idle code is not received yet (“No” at S203), then the serializer 22 determines whether or not the clock #X is less than 6 (S204). If it is less than 6 (“Yes” at S204), then the microprocessor 16 increments X by 1 and, then makes this process return to S202. Otherwise (“No” at S204), the microprocessor 16 makes this process return to S201.

On the other hand, if the idle code is detected (“Yes” at S203), then the serializer 22 selects the clock #X (S206). Then, it identifies the value of the clock #X (S207). If the value is one of #1 through #4, then the process proceeds to a Fibre Channel process at S211. Otherwise, if the value is #5 or #6, then the process proceeds to an Ethernet process at S212.

A subsequent process differs depending on the protocol. First, the serializer 22 extracts a frame of Fibre Channel or Ethernet (S211/S212). Second, the coder/decoder 26 decodes the extracted frame.

The multi-protocol process unit 30 (the Fibre Channel process unit 32 or the Ethernet process unit 36) subjects the decoded frame to a process according to Fibre Channel or Ethernet, such as deleting headers (S231/S232). Up to this point, the receiving process has been described.

A description will be given below, of a process in which a frame is sent. The multi-protocol process unit 30 (the Fibre Channel process unit 32 or the Ethernet process unit 36) subjects frames of Fibre Channel or Ethernet to a coding process in accordance with Fibre Channel or Ethernet, such as adding headers (S241/S241).

Next, the serializer 22 selects a clock #X corresponding to the protocol of the frames (S251). Then, the coder/decoder 26 subjects the frames to 8B to 10B coding (S252).

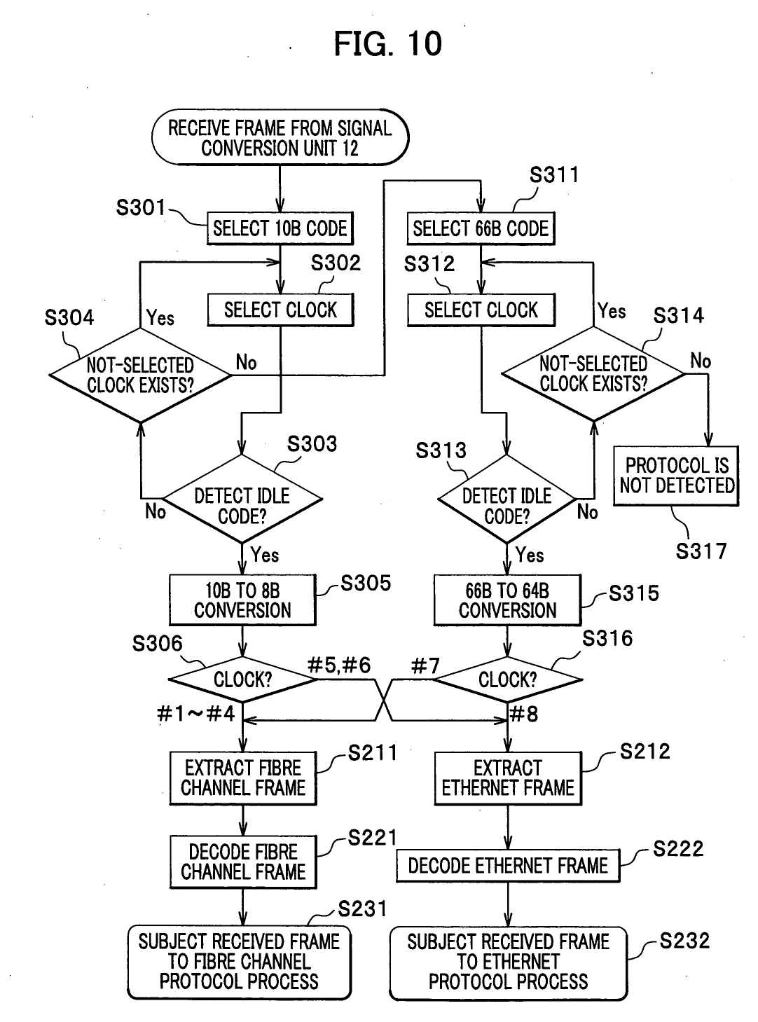

FIG. 10 shows a flowchart of a process in a frame is received by employing multiple coding schemes. This flowchart shows a communication process, assuming the clock supply unit 20 contains data shown in FIG. 4B. In FIG. 10, two schemes (8B/10B and 64B/66B coding) are employed. Note that the same reference numerals are given to the same steps as those of FIG. 9, and duplicate description therefore is omitted.

The 8B/10B coding (S301 to S306) will be described below. First, the coder/decoder 26 selects a 10B code (S301). Second, the serializer 22 selects a clock (S302) and, then determines whether or not an idle code of the clock selected at S302 is detected (S303).

If the idle code is not detected (“No” at S303), then the serializer 22 determines whether or not clocks which have not been selected at S302 and which is registered in the clock supply unit 20 are present (S304). If the unselected clock is present (“Yes” at S304), then the unselected clock is selected at S302. Otherwise, if “No” at S304, then a process of a 64B/66B coding (S311 to S316) is performed.

When the idle code is detected (“Yes” at S303), the coder/decoder 26 converts a 10B code into an 8B code (S305). In this case, the serializer 22 branches a subsequent process into two steps, depending on the clock selected at S302 (S306). If the clock is one of #1 and #4, then a Fibre Channel process (S211, S221 and S231) is performed. Otherwise, if the clock is #5 or #6, then an Ethernet process (S212, S222 and S232) is performed.

A process of the 64B/66B coding (S311 to S316) will be described below. The coder/decoder 26 selects a 66B code (S311). Subsequently, the serializer 22 selects a clock (S312) and, then determines whether or not an idle code of the clock selected at S312 is detected (S313).

When the idle code is not detected (“No” at S313), then the serializer 22 determines whether or not clocks which have not been selected at S312 and which is registered in the clock supply unit 20 are present (S314). If the unselected clock is present (“Yes” at S314), then the unselected clock is selected. Otherwise (“No” at S314), the microprocessor 16 renders the state of a protocol “not received” (S317).

If the idle code is detected (“Yes” at S313), then the coder/decoder 26 converts a 66B code to a 64B code (S315). The serializer 22 branches a subsequent process into two steps, depending on the clock selected at S312 (S316). If the clock is #7, then the serializer 22 performs a Fibre Channel process (S211, S221 and S231). Otherwise, if the clock is #8, then an Ethernet process (S212, S222 and S232) is carried out.

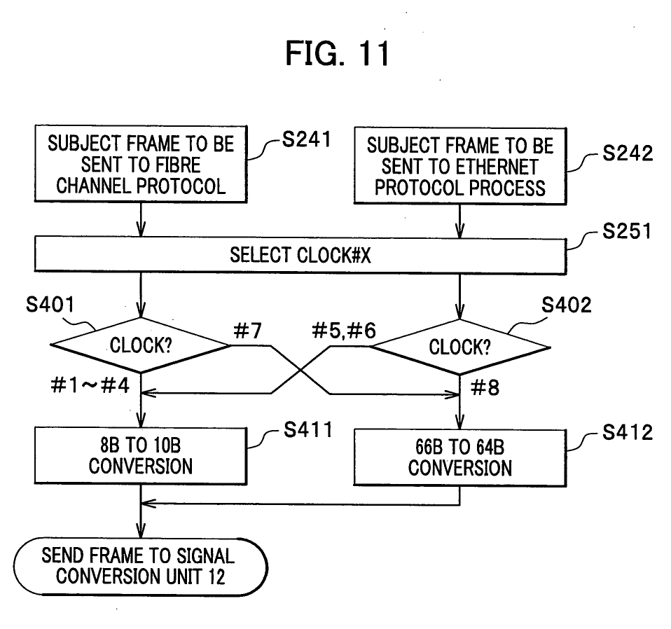

FIG. 11 shows a flowchart of process in which a frame is sent with multiple coding schemes. This flowchart shows the sending process, assuming that the clock supply unit 20 contains data shown in FIG. 4B. In this figure, two schemes (8B/10B and 64B/66B coding) are employed in combination. Note that the same reference numerals are given to the same steps as those of FIG. 9, and duplicate description therefore is omitted.

First, the network interface 1 performs the process (S241, S242 and S251) shown in FIG. 9. Second, the serializer 22 branches a subsequent process into two steps, depending on the clock (S401 and S402).

If the clock is one of #1 through #4 (Fibre Channel frame) or if the clock is #5 or #6 (Ethernet frame), then the coder/decoder 26 converts an 8B to 10B code (S411). Otherwise, the clock is #7 (Fibre Channel frame) or #8 (Ethernet frame), then the coder/decoder 26 converts a 66B to 64B code (S411).

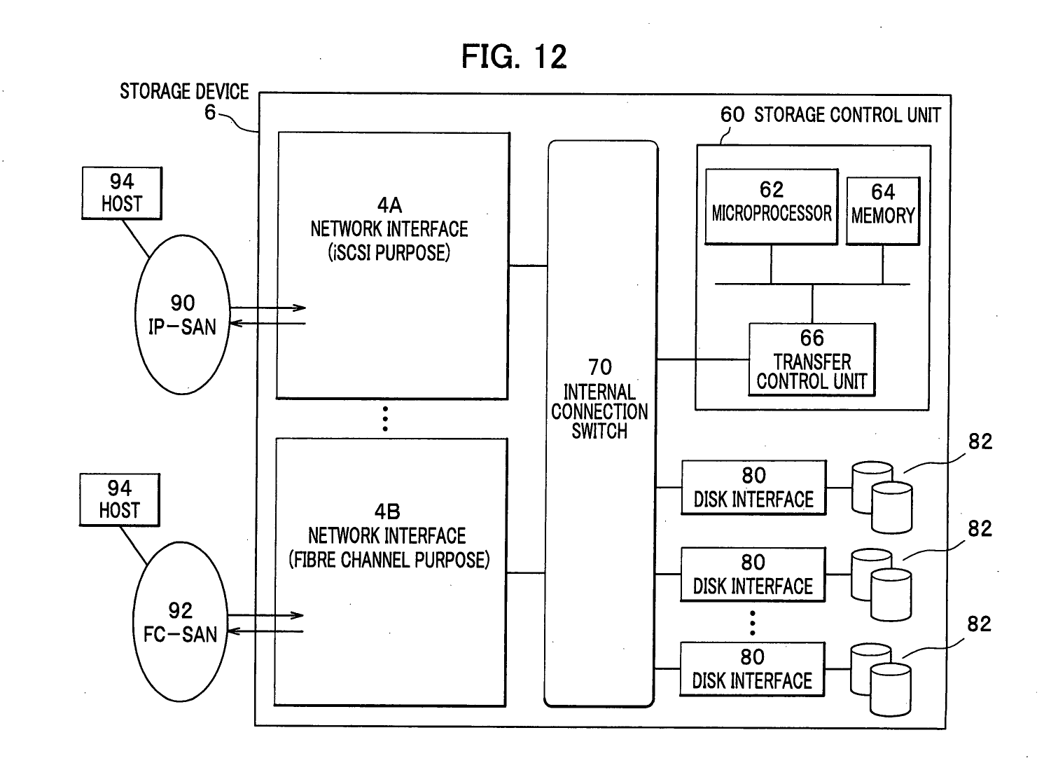

Up to this point, the operation of the computing system has been described. Subsequent to this description, the prominent effect will be explained by making it clear what the computing system of this embodiment shown in FIGS. 1 to 11 differs from that of comparative examples shown in FIGS. 12 to 15.

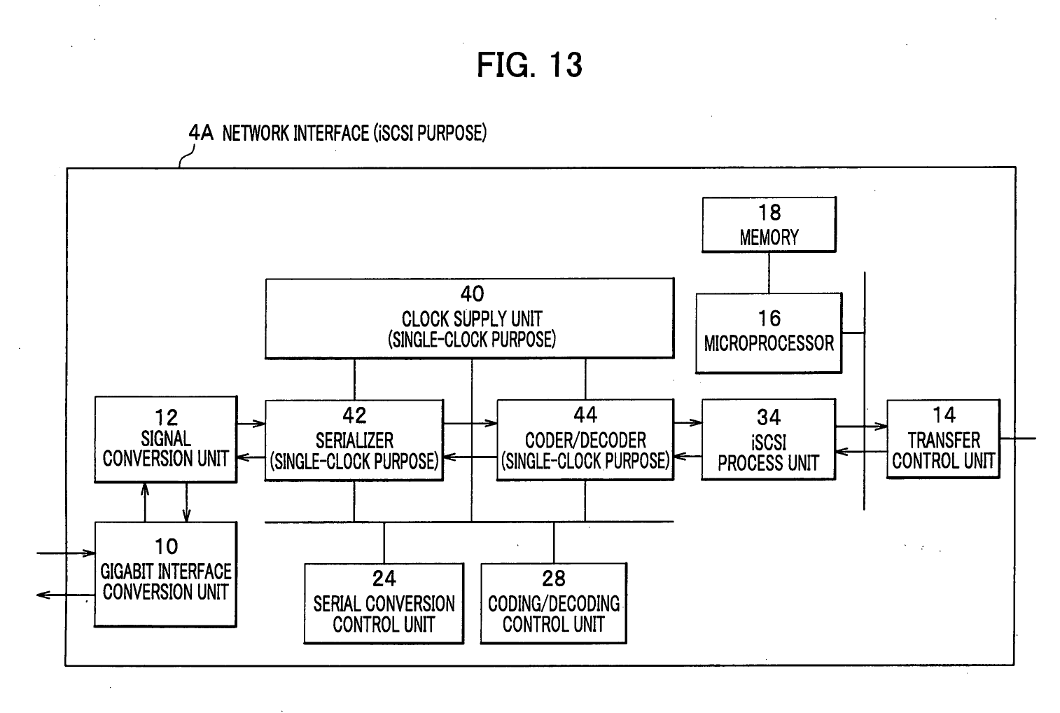

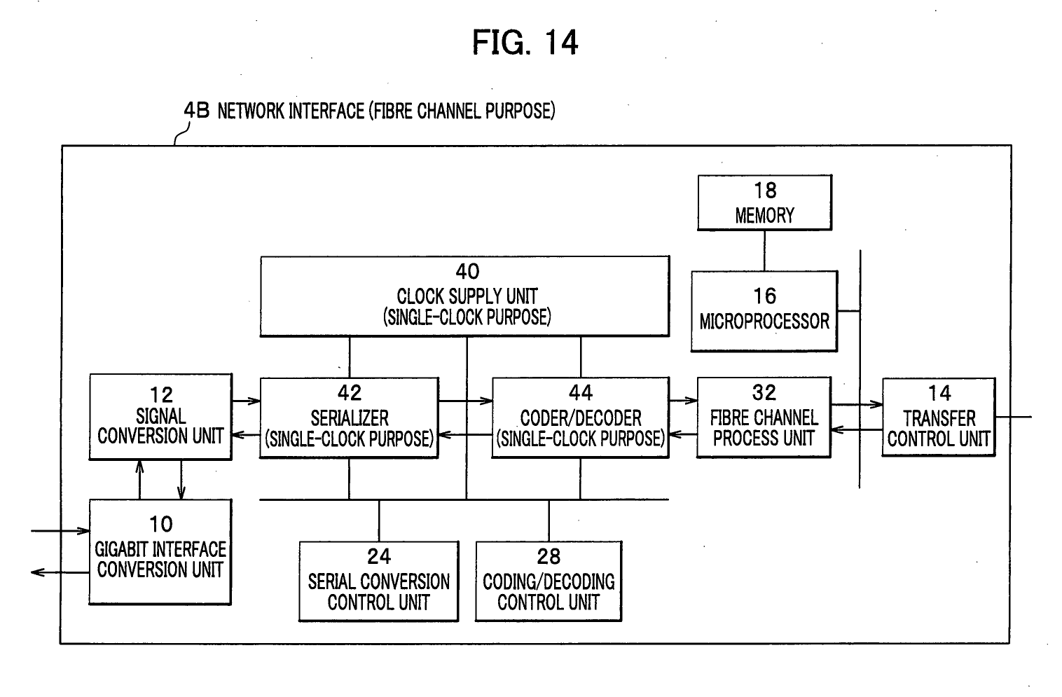

In FIG. 12, a storage device 6 of a computing system in a comparative example is shown. The storage device 6 needs to be equipped with a network interface for each protocol employed in a network to which the computing system is connected. To give an example, referring to FIG. 12, an IP-SAN90 in compliance with iSCSI is connected to a network interface (iSCSI purpose) 4A of FIG. 13, and a FC-SAN92 in compliance with Fibre Channel connected to a network interface (Fibre Channel purpose) 4B of FIG. 14.

Neither of the network interfaces of FIGS. 13 and 14 can be adapted for multiple protocols. Therefore, the number of relations between clock frequencies and protocols is limited to one. Each component in the network interface 1 of FIG. 2 operates for multi-clock purpose, whereas those of FIG. 13 and FIG. 14 operate for single-clock purpose. Specifically, the clock supply unit (single-clock purpose) 40, the serializer (single-clock purpose) 42, and the coder/decoder (single-clock purpose) 44 operate for single-clock purpose. The interfaces of FIGS. 13 and 14 each have a single-protocol process unit (the iSCSI process unit 34 of FIG. 13 or the Fibre Channel process unit 32 of FIG. 14), instead of the multi-protocol process unit 30 of FIG. 2.

As described above, since the devices of the comparative examples need to have a network interface for each protocol, it is inevitable that network interface boards are provided for each protocol. Hence, a vendor of the storage device 6 is necessary to bear development and control costs of individual network interface boards. In addition, a user of the storage device 6 absorbs increased introduction costs, because he or she needs to purchase a network interface board per a protocol.

In contrast, the computing system of this embodiment as shown in FIG. 1 has the network interface 1 that can deal with different protocols used on a network. This enables multiple protocols to be handled without exchanging the network interface. Thus, any desired protocols can be employed between each host 94 and the storage device 6, thereby constituting an optimized computing system.

Moreover, in this computing system, by providing the network interface with multiple ports, multiple protocols for corresponding ports can be employed. This allows many protocols to be supported by the minimum number of the network interfaces, thereby decreasing introduction costs of the storage device 6 towards a user.

The present invention is not limited to the above embodiment, and it can be modified appropriately.

To give an example, in this embodiment, the serializer 22 identifies a protocol, based on the clock frequency of the detected idle code. However, an administrator may define the types of a clock and of a frame before the connection with a network, so that unspecified protocols are not used. Accordingly, an administrator may specify a protocol by using a setting file or something similar, before the connection.

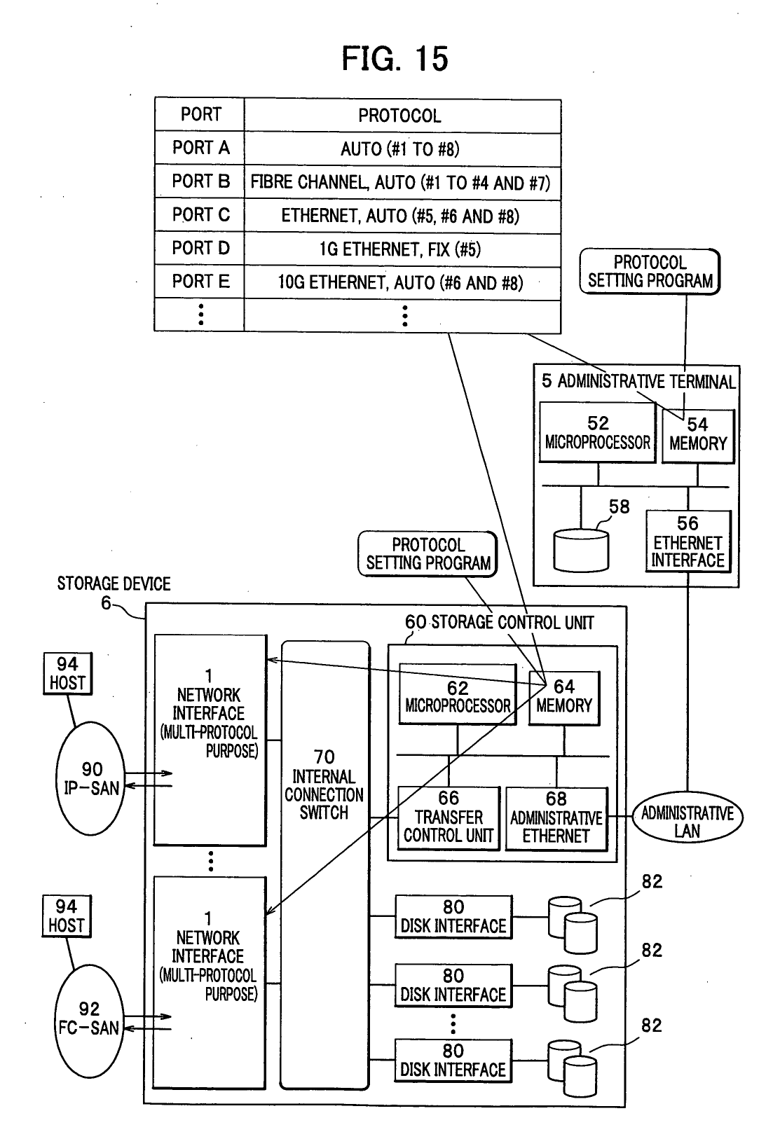

Referring to FIG. 15, an administrative terminal 5 is a computer that includes a microprocessor 52, a memory 54, an Ethernet interface 56, and a storage means 58. The Ethernet interface 56 is a network interface connected to the administrative Ethernet 68 of the storage device 6 through an administrative LAN. The administrative terminal 5 and the storage device 6 operate as follows by executing a protocol setting program.

First, the administrative terminal 5 sends the port setting table stored in the memory 54 to the memory 64 in the storage device 6. Second, the storage device 6 sets ports of each network interface 1 in the storage device 6, based on the port setting table stored in the memory 64.

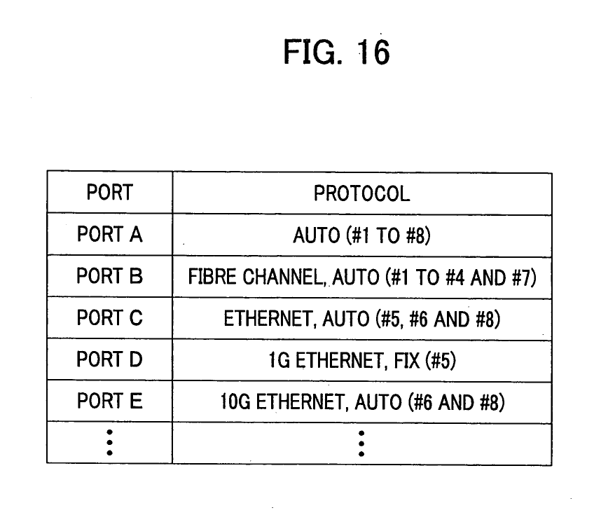

Referring to FIG. 16, in this table, the term “auto” in a protocol field means a protocol to be used in response to the detection of its idle code, and the term “fix” in the protocol field means a protocol to be used, regardless of the detection of its idle code. All protocols that are not described in this field are not used, regardless of the detection of their idle codes.

In a port A, protocols corresponding to the clocks #1 to #8 are used automatically in response to the detection of their idle codes, respectively. In a port B, protocols corresponding to clocks #1 to #4 and clock #7 (Fibre Channel) are used automatically in response to the detection of their idle codes, respectively. However, protocols corresponding to clocks #5, #6 and #8 (Ethernet) are not used, regardless of the detection of their idle codes.

The components of the network interface 1 can be implemented not only by a program executed by the microprocessor 16, but also by a program executed by an application specific integrated circuit (ASIC) or a programmable ASIC. Alternatively, it may be implemented by a protocol chip into which one or more components of a logic circuit are integrated. Moreover, the above program may be integrated in a computer readable recording medium.

Each component of the multi-protocol process unit 30 may be a removable storage medium, and a program is read from this medium, and is then executed. This makes it possible to add or change a protocol merely by exchanging the storage medium, instead of by exchanging the network interface 1 itself, so that the storage device is easy to maintain.

From the aforementioned explanation, those skilled in the art ascertain the essential characteristics of the present invention and can make the various modifications and variations to the present invention to adapt it to various usages and conditions without departing from the spirit and scope of the claims.

What is claimed is:

1. A network interface included in a storage device, the storage device connected to a network through which communications are done in accordance with one or more communication protocols, said network interface comprising:
a Physical Layer process unit for handling a signal defined by Physical Layer;
a clock supply unit for storing information on a plurality of relations between clock frequencies and communication protocols;
a serial conversion unit for determining a communication protocol, based on the information and a clock frequency of a received frame, or for determining a clock frequency of a frame to be sent, based on the information and a communication protocol of the frame; and
a multi-protocol process unit for handling the frame, in accordance with the determined communication protocol.

2. The network interface according to claim 1, further comprising a coding/decoding unit for coding or decoding the frame.

3. The network interface according to claim 1,
wherein the information stored in the clock supply unit comprises at least one relation between a clock frequency and Fibre Channel, and
wherein the multi-protocol process unit comprises a Fibre Channel process unit for handling the frame in accordance with Fibre Channel if the determined communication protocol is Fibre Channel.

4. The network interface according to claim 2,
wherein the information stored in the clock supply unit comprises at least one relation between a clock frequency and Fibre Channel, and
wherein the multi-protocol process unit comprises a Fibre Channel process unit for handling the frame in accordance with Fibre Channel if the determined communication protocol is Fibre Channel.

5. The network interface according to claim 1,
wherein the information stored in the clock supply unit comprises at least one relation between a clock frequency and Ethernet, and
wherein the multi-protocol process unit comprises an Ethernet process unit for handling the frame in accordance with Ethernet if the determined communication protocol is Ethernet.

6. The network interface according to claim 2,
wherein the information stored in the clock supply unit comprises at least one relation between a clock frequency and Ethernet, and
wherein the multi-protocol process unit comprises an Ethernet process unit for handling the frame in accordance with Ethernet if the determined communication protocol is Ethernet.

7. The network interface according to claim 1,
wherein the information stored in the clock supply unit comprises at least one relation between a clock frequency and iSCSI, and
wherein the multi-protocol process unit comprises an iSCSI process unit for handling the frame in accordance with iSCSI if the determined communication protocol is iSCSI.

8. The network interface according to claim 2,
wherein the information stored in the clock supply unit comprises at least one relation between a clock frequency and iSCSI, and
wherein the multi-protocol process unit comprises an iSCSI process unit for handling the frame in accordance with iSCSI if the determined communication protocol is iSCSI.

9. The network interface according to claim 1,
wherein the multi-protocol process unit comprises an application specific integrated circuit (ASIC).

10. The network interface according to claim 2,
wherein the multi-protocol process unit comprises an application specific integrated circuit (ASIC).

11. The network interface according to claim 1,
wherein the network comprises IP-SAN and FC-SAN.

12. The network interface according to claim 2,
wherein the network comprises IP-SAN and FC-SAN.

13. A computing system comprising:
a network through which communications are done in accordance with one or more communication protocols;
at least one storage device connected to the network;
at least one host connected to the network; and
a network interface included in the storage device, said network interface comprising:
a Physical Layer process unit for handling a signal defined by Physical Layer;
a clock supply unit for storing information on a plurality of relations between clock frequencies and communication protocols;
a serial conversion unit for determining a communication protocol, based on the information and a clock frequency of a received frame, or for determining a clock frequency of a frame to be sent, based on the information and a communication protocol of the frame; and
a multi-protocol process unit for handling the frame, in accordance with the determined communication protocol.

14. The computing system according to claim 13, wherein the network comprises IP-SAN and FC-SAN.
